(19) United States
(12) Patent Application Publication
(10) Pub. No.: US 2004/0011453 A1
(43) Pub. Date: Jan. 22, 2004

(54) Ceramic green body, method of manufacturing a green body of this type and a method of manufacturing a ceramic body using the green body

(76) Inventors: Andreas Roosen, Erlangen (DE); Thomas Schulte, Stuttgart (DE); Markus Siebert, Leonberg (DE); Stephan Zoellner, Hamburg (DE)

Correspondence Address: KENYON & KENYON, ONE BROADWAY, NEW YORK, NY, 10004, US

(21) Appl. No.: 10/332,298

(22) PCT Filed: Jun. 20, 2001
(86) PCT No.: PCT/DE01/02278

(30) Foreign Application Priority Data
Jul. 4, 2000 (DE) 10032333.2

(51) Int. Cl. C03B 29/00

(52) U.S. Cl. 156/89.11

(57) ABSTRACT

A ceramic green body made up of at least two ceramic green sheets that are glued together with a liquid adhesive is described. Further, a method of manufacturing a ceramic green body of this type is described, the surface of a first ceramic green sheet initially being provided at least in sections and at least on one side with the liquid adhesive, and the first ceramic green sheet being subsequently glued to a second ceramic green sheet. Finally, it is proposed to manufacture a ceramic body using this ceramic green body, which may be used, for example, in planar, ceramic exhaust gas sensors, or in ceramic multilayer hybrids as circuit carriers. To this end, after being glued, the ceramic green body is subjected to a heat treatment, during which the polymer matrix of the ceramic green sheets is first at least largely thermally decomposed and/or evaporated, and the body that remains is subsequently sintered.

The invention relates to a ceramic green body, a method of manufacturing a ceramic green body of this type and a method of manufacturing a ceramic body using the ceramic green body according to the definition of the species in the main claim.

### BACKGROUND INFORMATION

In the manufacture of planar ceramic exhaust gas sensors or of hybrid circuit carriers based on ceramic multilayer hybrids, it is known to bond or laminate ceramic green sheets into a ceramic green body by a thermocompression method, i.e., by applying pressure.

The ceramic laminating technique known per se is generally based on ceramic green sheets manufactured, for example, by sheet casting. These sheets are typically 5 μm to 2 mm thick and are usually made up of ceramic powder that is embedded in a polymer matrix, frequently based on polyvinyl butyral. Added plasticizers often also give these green sheets a certain flexibility.

Before the individual ceramic green sheets are laminated, they are frequently structured corresponding to the particular application, i.e., for example, provided with recesses, feedthroughs, structured functional layers or printed conductors. For this purpose, metal pastes, for example, are imprinted on the individual ceramic green sheets.

The manufacture of ceramic green sheets and their processing into ceramic multilayer hybrids is described for example, in P. Boch et al., “Tape Casting of Al₂O₃/ZrO₂ Laminated Composites,” J. Am. Ceram. Soc., volume 69, 8, (1986), C 191 to C 192, or A. Roosen, “Basic Requirements for Tape Casting of Ceramic Powders,” Ceram. Transactions, vol. 1, Part B, Ceramic Powder Science, Am. Ceram. Soc., Columbus, 1988, pages 675 to 692.

Known thermocompression methods to manufacture ceramic bodies by laminating ceramic green sheets have the disadvantage that the heating of the ceramic green sheets required during laminating is time-consuming and that, for example, functional layers manufactured on the surface of the ceramic green sheets may be deformed by the pressure that must be applied.

To overcome these disadvantages, it has already been proposed in German Patent Application 197 25 948 A1 that the lamination of the individual ceramic green sheets into a green body be carried out by gluing using double-sided adhesive tape. This method is also described as scold low pressure lamination. In addition, the production of an adhering connection between the ceramic green sheets initially glued to each other by final sintering into a ceramic body is known

However, the “cold low pressure lamination” known from German Patent Application 197 25 948 A1 has the disadvantage that it is very difficult to prevent the inclusion of air bubbles between the double-sided adhesive tape and the ceramic green sheets to be glued, which may result in delamination and malfunctions in some places. This method thus has only limited applicability to the manufacture of planar multilayer hybrids for electronic circuits or of ceramic sheets for gas sensors. In addition, the use or the application of an adhesive tape of this type, for example, in the manufacture of multilayer hybrids is very difficult to integrate into customary thick-sheet methods such as screen printing.

### ADVANTAGES OF THE INVENTION

In contrast to the related art, the ceramic green body of the present invention, the method of manufacturing a green body of this type according to the present invention and the method of manufacturing a ceramic body using this green body has the advantage that it makes it possible to combine the advantages of conventional thick-sheet technology with the advantages of cold low-pressure lamination. Thus the use of a thermocompression method to combine the ceramic green sheets may be advantageously omitted while, however, the danger of delamination by bubble formation is eliminated.

Overall, this results in a considerable simplification and shortening of the manufacturing process as well as an improvement in the quality of the ceramic bodies obtained. The methods of the present invention thus result in considerable cost savings in the manufacture of multilayer hybrids or gas sensors, for example. In other respects, the method of the present invention for gluing the ceramic green sheets also allows a simple leveling so that it is possible to level out at least partially any surface waviness of the individual glued green sheets that may be initially present.

Advantageous refinements of the present invention result from the measures stated in the dependent claims.

It is thus advantageous in particular if the liquid adhesive is applied to the green sheets using a screen printing method which is known per se. It is advantageously possible to adjust the viscosity of the liquid adhesive used by adding a solvent in the manner desired. In addition, the screen printing makes it possible to adapt the thickness of the applied liquid adhesive layer to the green body sheets or to adjust it in a defined manner.

It is further advantageous that it is possible to manufacture acrylate-based liquid adhesives both on the basis of an organic solvent such as acetone, ethyl acetate and/or benzene as well as on the basis of water and use them for screen printing. This advantageously makes it possible to match the liquid adhesive used to the composition of the ceramic green sheets to be glued.

In a further advantageous manner, the solvent added, for example, to the liquid adhesive for application by screen printing, or by spraying as an alternative, may be drawn off again in a downstream drying step before the ceramic sheets provided with the liquid adhesive are then stacked and thus glued together.

In manufacturing the ceramic body, it is further advantageous that in the course of the heat treatment carried out, the polymer matrix, i.e., the organic components contained in the ceramic green sheets such as binders, plasticizers and dispersing agents, if present, are thermally decomposed and/or evaporated at temperatures from 80° C. to 350° C., the liquid adhesive used still being thermally stable at these temperatures, however.

Furthermore, it is an advantage that the liquid adhesive used initially has a high viscosity at the temperatures required for the thermal decomposition of the polymer matrix so that at these temperatures the liquid adhesive penetrates into the ceramic green sheets to be glued together to only a negligible degree. In this stage of the method of the present invention to manufacture the ceramic body, the green sheets glued together are thus initially essentially held together by the liquid adhesive on the surface of the green sheets.

After the polymer matrix is then thermally decomposed and/or evaporated by the heat treatment in the manner explained, the temperature is then increased during this or another heat treatment such that the liquid adhesive applied to the surface of the ceramic green sheets is initially liquified. These temperatures are typically 250° C. to 550° C. This advantageously causes the liquid adhesive to penetrate superficially into the remaining, very porous ceramic structure of the green sheets liberated from the polymer matrix, thus manufacturing an intimate and permanent gluing of adjacent green sheets.

As the temperature further increases, the adhesive is thermally decomposed so that the particles and/or the remaining ceramic structures are interlocked intimately and directly, and in a subsequent sintering step, they advantageously no longer separate or delaminate but instead they are sintered together to form an adhering bond.

The high temperatures of 800° C. to 1750° C., sometimes even as high as 2200° C., in the concluding sintering step to manufacture the ceramic body finally ensure that the liquid adhesive applied previously to the ceramic green sheets is at least extensively decomposed. Thus the ceramic body obtained has at least almost no residues of liquid adhesive and/or polymer matrix.

### DETAILED DESCRIPTION OF THE EXEMPLARY EMBODIMENTS

The exemplary embodiment explained is initially based on ceramic green sheets as already described in German Patent Application 197 25 948 A1.

The surfaces of one side of these ceramic green sheets are first provided with an acrylate-based liquid adhesive.

Preferred in particular is a liquid adhesive having a composition of 2-ethylhexyl acrylate and acrylic acid at a mass ratio of 90:10 to 99.5:0.5, 98:2 in particular. In this case, an acetone-benzene mixture is used, for example, as a solvent which is added to the liquid adhesive at a proportion of 60 to 70 percent by weight, 65 percent in particular.

As an alternative, the liquid adhesive may also have the composition 2-ethyhexyl acrylate, methyl acrylate and acrylic acid, these components then being used at a mass ratio of 75:20:5, for example. In this case, isopropanol is used as a solvent.

Admixture components which are known per se in the form of plasticizers and/or adhesive resins may also be added to the liquid adhesives explained above.

In addition, liquid adhesives containing maleic acid, itaconic acid, fumaric acid and/or their esters, or vinyl compounds, in particular, vinyl ester, vinyl acetate or vinyl alcohol and/or their esters may be considered as liquid adhesives.

In particular, the liquid adhesive is applied to the ceramic green sheets by first adding the solvent to the liquid adhesive and then printing the surface of one side of the ceramic green sheets using the screen printing method which is known per se.

However, as an alterative to application by printing, the liquid adhesive may, for example, be sprayed on.

As solvents used to dilute or adjust the viscosity of the liquid adhesive used for spraying or printing, water, acetone, gasoline or ethyl acetate or a mixture of them may be used in addition to the solvents already named depending on the composition of the liquid adhesive.

The ceramic green sheets used, which are known per se, are made, for example, of ceramic particles embedded in a matrix, for example, yttrium-stabilized ZrO₂ powder particles.

The matrix is, for example, a polymer such as polyvinyl butyral to which a plasticizer is added, if necessary.

The typical thickness of the ceramic green sheets used is approximately 5 μm to 2000 μm, in particular, 10 μm to 200 μm.

In other respects, surface areas of the ceramic green sheets used may be further provided with a functional layer and/or recesses, feedthroughs in particular, and/or printed conductors in a manner known per se, by imprinting a metal paste, for example, before the liquid adhesive is applied. Such ceramic bodies are known as ceramic multilayer hybrids for circuit carriers.

After the liquid adhesive has been applied to the surface of one side of the ceramic green sheets which were, if necessary, previously provided with a functional layer and/or recesses, the ceramic green sheets prepared in this manner are stacked, and if the own weight of the green sheets is inadequate, they are glued together with an additional light pressure, if necessary. Hand pressure or light roller pressure is sufficient for this purpose.

This results in a ceramic green body which is made up of at least two, preferably however, 3 to 8 ceramic green sheets that are stacked on each other and glued together in pairs.

In order to draw off the solvent added to apply the liquid adhesive by screen printing before the individual green sheets are stacked, it is in other respects advantageous to first dry the individual green sheets provided with the liquid adhesive before stacking at a temperature of 80° C. to 150° C., in particular 90° C. to 110° C. for a period of 3 minutes to 60 minutes.

After the ceramic green sheets provided with liquid adhesive are stacked and thus glued to form the ceramic green body used as an intermediate product, it is then subjected to a heat treatment.

For this purpose, the green body is first heated to a temperature at which the polymer matrix of the ceramic green sheets is thermally decomposed and/or evaporated. These temperatures typically amount to 80° C. to 350° C. Of the individual green sheets, there thus remain porous, ceramic structures that are glued to each other via intermediate layers of liquid adhesive.

Subsequently, the temperature is then increased or there is a second heat treatment, the green body that was previously heated or freed from the polymer matrix now being heated to temperatures at which the adhesive liquefies. These temperatures customarily amount to 250° C. to 350° C. This liquefying of the applied adhesive between the individual ceramic green sheets is accompanied by at least superficial penetration of the adhesive into the remaining, porous ceramic structure of the ceramic green sheets. This results in a permanent and intimate gluing.

As the temperature further increases to 350° C. to 650° C., the adhesive is thermally decomposed. The ceramic particles of the glued green sheets now in direct contact with each other form a ceramic structure that is very intimately interlocked.

Subsequently, the body pretreated in this manner is heated to higher temperatures of 850° C. to 2200° C. for compaction and sintering.

Moreover, the sheet stack manufactured may also be weighted with an additional weight during the entire heat treatment of the glued green sheets.

During this final sintering step, the ceramic body is manufactured, which is now at least largely free from organic components.

What is claimed is:

1. A ceramic green body having at least two ceramic green sheets glued to one another, wherein the green sheets are glued to one another with a liquid adhesive.

2. The green body as recited in claim 1, wherein the liquid adhesive is an acrylate-based adhesive which contains in particular a copolymer based on acrylic acid and methylacrylic acid and/or their esters having 1 to 25 carbon atoms or substituted acrylamides and/or methacrylamides.

3. The green body as recited in claim 1 or 2, wherein the liquid adhesive contains at least one component selected from the group maleic acid, itaconic acid, fumaric acid and/or their esters and/or admixture components, in particular plasticizers and/or adhesive resins.

4. The green body as recited in at least one of the preceding claims, wherein the liquid adhesive contains vinyl compounds, in particular vinyl ester, vinyl acetate, vinyl alcohol and/or their esters.

5. The green body as recited in at least one of the preceding claims, wherein the liquid adhesive contains a solvent, in particular water or an organic solvent such as acetone, ethyl acetate, gasoline or a mixture thereof.

6. The green body as recited in at least one of the preceding claims, wherein the liquid adhesive has been at least partially thermally cross-linked initially to increase the cohesion.

7. The green body as recited in at least one of the preceding claims, wherein the ceramic green sheets have ceramic particles embedded in a matrix.

8. The green body as recited in claim 7, wherein the matrix includes a polymer, polyvinyl butyral in particular.

9. The green body as recited in at least one of the preceding claims, wherein before gluing, the surface of at least one ceramic green sheet has been provided at least in sections with at least one functional layer and/or recesses, feedthroughs in particular, and/or printed conductors.

10. The green body as recited in at least one of the preceding claims, wherein the green body has a stack of green sheets glued to one another.

11. A method of manufacturing the ceramic green body as recited in at least one of the preceding claims, wherein initially the surface of a first ceramic green sheet is provided with the liquid adhesive at least in sections and at least on one side, and thereafter the first ceramic green sheet is glued to a second ceramic green sheet.

12. The method as recited in claim 11, wherein the liquid adhesive is applied at least in sections to one side of the surface of the first ceramic green sheet, in particular is printed or sprayed on.

13. The method as recited in claim 11 or 12, wherein the green sheets provided with the liquid adhesive are dried before gluing at a temperature of 80° C. to 120° C. for a period of 3 minutes to 60 minutes.

14. The method as recited in at least one of claims 11 through 13, wherein the ceramic green sheets are stacked after being provided with the liquid adhesive and are glued to each other in particular using a slight contact pressure.

15. A method of manufacturing a ceramic body, of ceramic sheets or ceramic multilayer hybrids in particular, using a ceramic green body as recited in at least one of the preceding claims, wherein the ceramic green body is subjected to at least one heat treatment after gluing, the polymer matrix of the green sheets being at least largely thermally decomposed and/or evaporated and the green body subsequently being sintered.

16. The method as recited in claim 15, wherein the heat treatment is carried out in such a way that the polymer matrix is initially at least largely thermally decomposed and/or evaporated and thereafter the liquid adhesive applied to the green sheets is thermally liquified.

17. The method as recited in claim 15 or 16, wherein the polymer matrix is thermally decomposed and/or evaporated at temperatures from 80° C. to 350° C.

18. The method as recited in claim 16, wherein the liquid adhesive is thermally liquified at temperatures from 250° C. to 550° C.

19. The method as recited in claim 16, wherein the liquid adhesive is thermally decomposed at temperatures from 350° C. to 650° C.

20. The method as recited in claim 18, wherein the sintering takes place at temperatures from 800° C. to 2200° C.
